(19) United States
(12) Patent Application Publication
(10) Pub. No.: US 2026/0124985 A1
(43) Pub. Date: May 7, 2026

(54) ROAD SURFACE DRAWING APPARATUS FOR VEHICLE

(71) Applicant: TOYOTA JIDOSHA KABUSHIKI KAISHA, Aichi-ken (JP)

(72) Inventors: Masaya WATANABE, Nagakute-shi (JP); Katsutoshi TSUZUKI, Nagoya-shi (JP); Masakazu DEAI, Okazaki-shi (JP); Akinori SAKAI, Nayoro-shi (JP); Kento NAKAZATO, Tama-shi (JP)

(21) Appl. No.: 19/348,791

(22) Filed: Oct. 3, 2025

(30) Foreign Application Priority Data
Nov. 5, 2024 (JP) 2024-193471

(51) Int. Cl. B60Q 1/26; B60Q 1/34

(52) U.S. Cl. CPC B60Q 1/2603; B60Q 1/34; B60Q 2300/056; B60Q 2300/14; B60Q 2300/31; B60Q 2400/50

(57) ABSTRACT

A road surface drawing apparatus for a vehicle includes a road surface drawing lamp that irradiates a patterned light and a controller that controls the road surface drawing lamp. The controller determines a plurality of conditions including a first condition, a second condition, and a third condition each time the vehicle travels a fixed distance. The first condition is that the outside temperature of the vehicle is equal to or lower than a predetermined temperature. The second condition is that a brightness of light reflected from an area illuminated by a headlight of the vehicle is equal to or lower than a predetermined brightness. The third condition is that at least one of ABS, ESC, and TRC has been activated during the most recent predetermined distance traveled by the vehicle. The controller performs a glare reduction control of the patterned light when the plurality of conditions is satisfied.

### CROSS REFERENCE TO RELATED APPLICATION

This application claims priority to Japanese Patent Application No. 2024-193471 filed on Nov. 5, 2024, which is incorporated herein by reference in its entirety including the specification, claims, drawings, and abstract.

### TECHNICAL FIELD

This specification discloses a road surface drawing apparatus for a vehicle that draws images on a road surface surrounding the vehicle.

### BACKGROUND

It has been proposed to equip a vehicle with a road surface drawing apparatus. The road surface drawing apparatus draws images on a road surface around the vehicle. The road surface drawing apparatus, for example, irradiates a patterned light in conjunction with a turn signal lamp to draw images of predetermined shapes on the road surface.

Patent Literature 1 (JP 2019-51792 A) discloses a road surface drawing apparatus that irradiates a patterned light from a vehicle onto a road surface. This road surface drawing apparatus detects a road surface image drawn on the road surface by the irradiated patterned light, and when the detected road surface image is missing or distorted, changes the position or range on the road surface where the patterned light is irradiated.

### SUMMARY

During the winter season, a frozen road surface such as mirror-smooth ice or black ice (hereinafter referred to as “mirror-smooth ice, etc.”) may appear. On the frozen road surface such as mirror-smooth ice, etc., an incident light is easily reflected like a mirror. Therefore, there is a risk that the patterned light from the road surface drawing apparatus may be reflected like a mirror on mirror-smooth ice, etc., and the reflected light may cause glare to pedestrians, etc.

This specification discloses a road surface drawing apparatus for a vehicle that can suppress glare caused by a patterned light from the road surface drawing apparatus being reflected off a frozen road surface and causing discomfort to people outside the vehicle.

A road surface drawing apparatus for a vehicle disclosed in this specification includes a road surface drawing lamp that irradiates a patterned light toward a road surface; and a controller that controls the road surface drawing lamp. The controller determines a plurality of conditions including a first condition, a second condition, and a third condition each time the vehicle travels a fixed distance. The first condition is that an outside temperature of the vehicle is equal to or lower than a predetermined temperature at which the road surface may freeze. The second condition is that a brightness of light reflected toward the vehicle from an area illuminated by a headlight of the vehicle is equal to or lower than a predetermined brightness. The third condition is that at least one of an anti-lock brake control (ABS), which suppresses wheels of the vehicle from locking, a skid suppress control (ESC), which suppresses the vehicle from skidding, and a traction control (TRC), which suppresses wheels of the vehicle from spinning, has been activated during the most recent predetermined distance traveled by the vehicle. The controller performs a glare reduction control that stops irradiation of at least a part of the patterned light, reduces the amount of light of at least a part of the patterned light, or changes a pattern of at least a part of the patterned light when the plurality of conditions is satisfied.

According to this configuration, it is possible to detect a frozen road surface where specular reflection of the patterned light is likely to occur by using the first condition, the second condition, and the third condition. Note that the second condition is used to determine the nature of the road surface based on the brightness of the reflected light in the area illuminated by the headlights (referred to as the headlight illumination area). Specifically, when the brightness of the reflected light in the headlight illumination area is high, the road surface is determined to be a snow-covered road or similar surface where diffuse reflection is likely to occur (and specular reflection is unlikely to occur). On the other hand, when the brightness of the reflected light in the headlight illumination area is low, the road surface is determined to be a mirror-smooth ice, etc. where diffuse reflection is unlikely to occur (and specular reflection is likely to occur). According to the above configuration, when a frozen road surface such as a mirror-smooth ice, etc. which is prone to specular reflection of light, is detected using the first condition, the second condition, and the third condition, the glare reduction control such as stopping the irradiation of the patterned light is performed, thereby suppressing glare to people outside the vehicle caused by the patterned light being reflected from the frozen road surface.

In the road surface drawing apparatus for vehicle according to the present disclosure, the controller may determine the plurality of conditions each time the vehicle travels the fixed distance during which the glare reduction control is performed, and may terminate the glare reduction control when at least one of the first condition, the second condition, and the third condition is no longer satisfied.

According to this configuration, it is possible to detect that the road surface surrounding the vehicle is not a frozen road surface prone to specular reflection of the patterned light by using the first condition, the second condition, and the third condition. Then, the patterned light can be restored to its original form.

In the road surface drawing apparatus for vehicle according to the present disclosure, the patterned light may include a distal pattern element that is irradiated onto the road surface furthest from the vehicle when the glare reduction control is not performed, and the controller may stop irradiation of at least the distal pattern element of the patterned light in the glare reduction control.

Compared to the portion of the patterned light that is irradiated onto a road surface relatively close to the vehicle, the portion of the patterned light that is irradiated onto the road surface relatively far from the vehicle is reflected at a small angle from the road surface and travels forward, making it easier for the reflected light to be irradiated onto the faces of people outside the vehicle. According to the above configuration, since the irradiation of at least the distal pattern element of the patterned light is stopped in the glare reduction control, it is possible to suppress the irradiation of reflected light onto people's faces.

In the road surface drawing apparatus for vehicle according to the present disclosure, the patterned light may include a distal pattern element that is irradiated onto the road surface furthest from the vehicle, and the controller may reduce the amount of light of at least the distal pattern element of the patterned light in the glare reduction control compared to when the glare reduction control is not performed.

According to this configuration, since the amount of light of at least the distal pattern element of the patterned light in the glare reduction control is reduced, it is possible to reduce the amount of reflected light that may be directed toward people's faces.

In the road surface drawing apparatus for vehicle according to the present disclosure, the patterned light may include a distal pattern element that is irradiated onto the road surface furthest from the vehicle, and the controller, in the glare reduction control, may change a shape of the distal pattern element of the patterned light such that a tip of the distal pattern element of the patterned light on the road surface is closer to the vehicle than when the glare reduction control is not performed.

According to this configuration, in the glare reduction control, the tip of the distal pattern element of the patterned light on the road surface becomes closer to the vehicle, i.e., the patterned light is no longer irradiated onto the road surface relatively far from the vehicle, thereby suppressing the reflection of light onto people's faces.

According to the technology disclosed in this specification, it is possible to suppress glare caused by the patterned light from the road surface drawing apparatus reflecting off the frozen road surface and causing discomfort to people outside the vehicle.

### BRIEF DESCRIPTION OF DRAWINGS

Embodiments of the present disclosure will be described based on the following figures, wherein:

FIG. 1 is a schematic diagram showing patterned lights irradiated onto a frozen road surface;

FIG. 2 is a plan view illustrating patterned lights irradiated onto a road surface;

FIG. 3 is a block diagram showing a configuration of a system installed in a vehicle;

FIG. 4 is a flowchart showing a processing performed by a controller of a road surface drawing apparatus;

FIG. 5A is a diagram illustrating a patterned light;

FIG. 5B is a diagram illustrating a patterned light;

FIG. 5C is a diagram illustrating a patterned light;

FIG. 5D is a diagram illustrating a patterned light;

FIG. 5E is a diagram illustrating a patterned light.

### DESCRIPTION OF EMBODIMENTS

The embodiments will be described below with reference to the drawings. In all the drawings, the same reference numerals indicate the same elements, and duplicate explanations are omitted.

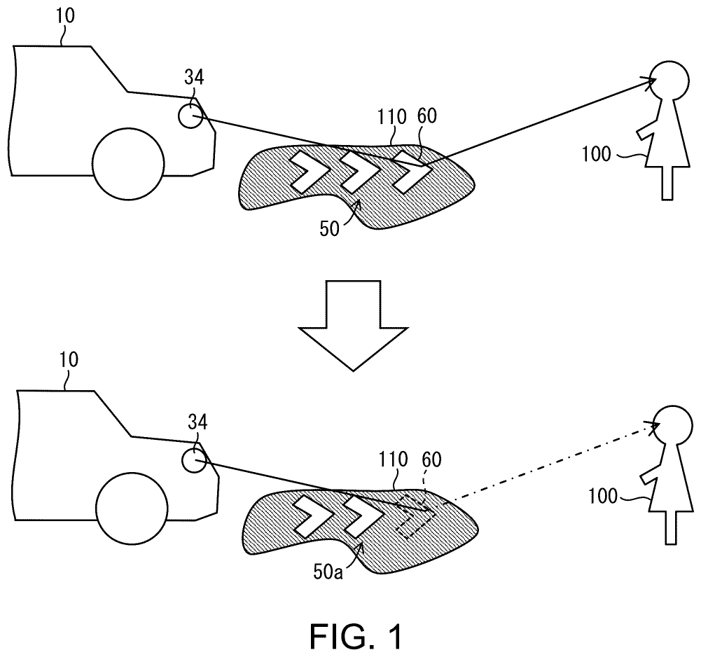

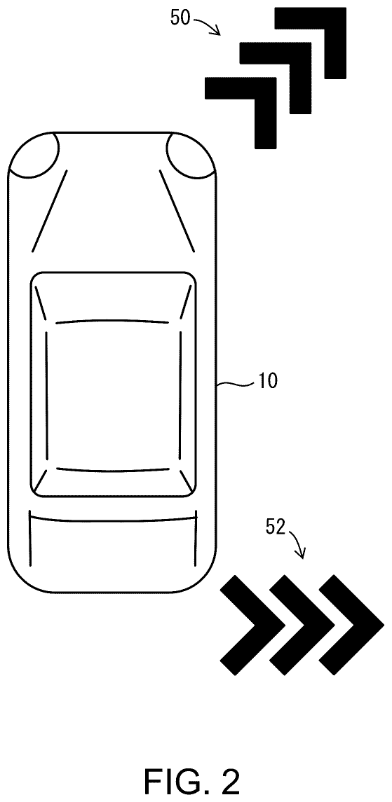

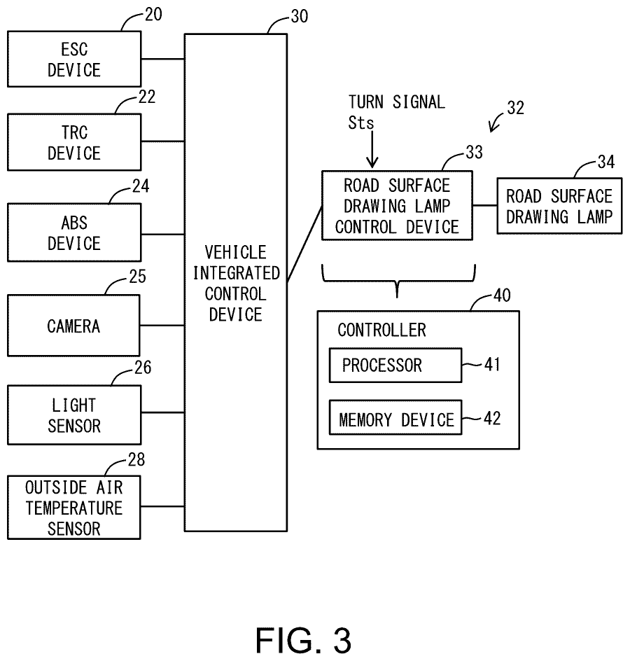

FIG. 1 is a schematic diagram showing patterned lights 50, 50a irradiated onto a frozen road surface 110. FIG. 2 is a plan view illustrating patterned lights 50, 52 irradiated onto a road surface. FIG. 3 is a block diagram showing a configuration of a system installed in a vehicle 10. As shown in FIG. 3, the vehicle 10 includes a road surface drawing apparatus 32 having a road surface drawing lamp 34.

As shown in FIGS. 1 and 2, the road surface drawing lamp 34 draws images indicating the behavior of the vehicle 10 on the road surface by irradiating the patterned lights 50, 52 onto the road surface surrounding the vehicle 10. The road surface drawing lamp 34 includes front light sources and rear light sources. The front light source of the road surface drawing lamp 34 irradiates the patterned light 50 toward the front or diagonally forward of the vehicle 10, as shown in FIG. 2. The front light sources of the road surface drawing lamp 34 are provided one each at the right end and left end of the front end of the vehicle 10. The rear light source of the road surface drawing lamp 34 irradiates patterned light 52 to the rear or diagonally rearward of the vehicle 10, as shown in FIG. 2. The rear light sources of the road surface drawing lamp 34 are provided one each at the right end and left end of the rear end of the vehicle 10.

The front patterned light 50 and the rear patterned light 52 both include a plurality of inverted V-shaped lights arranged in one direction. At least one of the front patterned light 50 and the rear patterned light 52 may include a plurality of rectangular lights arranged in one direction. The shapes of the patterned lights 50 and 52 are not limited.

As shown in FIG. 3, the road surface drawing apparatus 32 includes a road surface drawing lamp control device 33 and the road surface drawing lamp 34. The road surface drawing lamp control device 33 includes a controller 40. The controller 40 controls the road surface drawing lamp 34.

The controller 40 is a computer having a processor 41 and a memory device 42. This “computer” includes a microcontroller in which a computer system is incorporated into a single integrated circuit. FIG. 3 shows a single processor 41 and a single memory device 42. However, the controller 40 may include two or more processors 41 and two or more memory devices 42. The controller 40 may also be configured by combining a plurality of physically separated computers.

The vehicle 10 is provided with turn signal lamps at the right and left ends of the front end and at the right and left ends of the rear end. The driver of the vehicle 10 operates a turn signal switch when changing lanes or turning. The turn signal switch is a rotatable lever. When the turn signal switch is rotated to the left to turn it on, the turn signal lamps at the left front and rear ends flash. When the turn signal switch is rotated to the right to turn it on, the turn signal lamps at the right front and rear ends flash.

A turn signal Sts is output in response to operation of the turn signal switch by the driver. The turn signal Sts may include a signal indicating the direction of travel of the vehicle 10 and a signal indicating the flashing timing.

The turn signal Sts is input to the controller 40. The controller 40 controls the road surface drawing lamp 34 using the turn signal Sts. Specifically, the controller 40 controls the road surface drawing lamp 34 so that the patterned lights 50 and 52 flash in conjunction with the turn signal lamps. The controller 40 flashes the road surface drawing lamps 34 on the left front end and rear end (or only on the front end) in conjunction with the flashing of the turn signal lamps on the left front end and rear end. In addition, the controller 40 flashes the road surface drawing lamp 34 at the right front end and rear end (or only on the front end) in conjunction with the flashing of the turn signal lamps on the right front end and rear end. The flashing of the patterned lights 50 and 52 of the road surface drawing lamp 34 is in the same cycle as the flashing of the turn signal lamps.

As shown in FIG. 2, the patterned lights 50 and 52 have shapes indicating the direction of lane change or turn of the vehicle 10. The front patterned light 50 is irradiated onto the road surface in front of the vehicle 10 and in the direction of the lane change or turn (to the right in FIG. 2). The rear patterned light 52 is irradiated onto the road surface behind the vehicle 10 and in the direction of the lane change or turn (to the right in FIG. 2).

The patterned lights 50 and 52 may not be irradiated in a bright environment (such as on a sunny day). The controller 40 may irradiate the patterned lights 50 and 52 from the road surface drawing lamp 34 only when a relatively dark environment (such as a dark day, evening, or night) is detected by a light sensor 26 (see FIG. 3).

As shown in FIG. 3, the vehicle 10 includes an ESC device 20, a TRC device 22, an ABS device 24, a camera 25, a light sensor 26, an outside air temperature sensor 28, a vehicle integrated control device 30, and the road surface drawing apparatus 32.

The ESC device 20 performs a skid suppress control (ESC: Electronic Stability Control) to suppress the vehicle 10 from skidding. When the ESC device 20 detects an unstable state of the vehicle 10 during turning, it suppresses the vehicle 10's attitude from becoming disordered by controlling the braking force applied to the wheels and the driving force applied to the driven wheels, thereby stabilizing the vehicle 10's behavior. Note that the skid suppress control (ESC) is also referred to as Vehicle Stability Control (VSC).

The TRC device 22 performs a traction control (TRC: Traction Control) to suppress wheels of the vehicle 10 from spinning. The TRC device 22 suppresses wheel slip during starting/acceleration on slippery road surfaces, etc., by controlling the driving force to the driven wheels to ensure appropriate driving force according to road conditions, preventing the driving force from exceeding the friction force between the wheels and the road surface and causing the wheels to slip.

The ABS device 24 performs an anti-lock brake control to suppress wheels of the vehicle 10 from locking. Note that ABS stands for Anti-lock Brake System. The ABS device 24 controls the braking force applied to each wheel during braking of the vehicle 10 to prevent the braking force from exceeding the friction force between the wheel and the road surface, thereby preventing the wheel from locking and skidding.

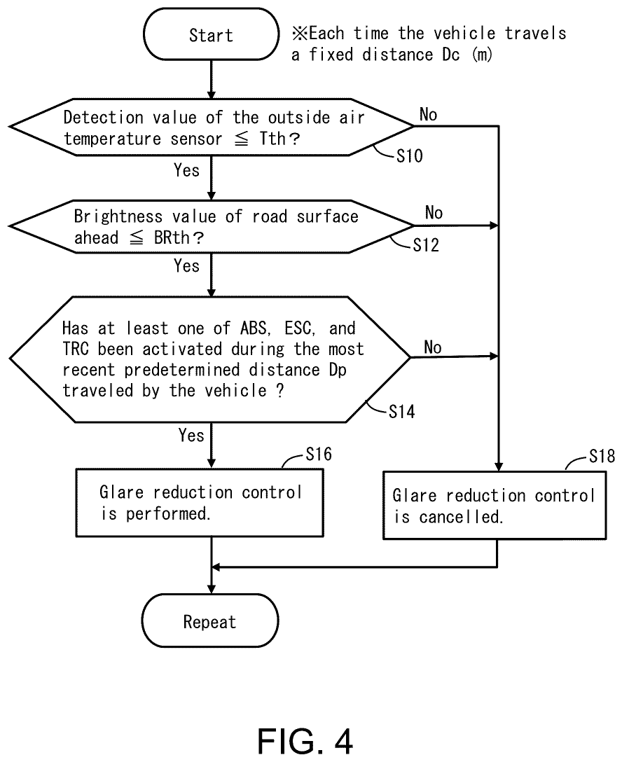

The camera 25 captures images of the front of the vehicle 10. The camera 25 may be a camera used for, for example, pre-crash safety, automatic high beam, etc. The pre-crash safety is a function that detects vehicles ahead, oncoming vehicles, pedestrians, etc., and emits a warning sound or activates the brakes. The automatic high beam is a function that automatically switches between high beams and low beams. In step S12 of FIG. 4 described later, the brightness of light (referred to as reflected light) reflected toward the vehicle 10 from the area illuminated by the headlights of vehicle 10 is detected using the image captured by the camera 25. Note that this reflected light may be the reflected light from the headlights of vehicle 10. However, this reflected light may also include, or instead of, light reflected from other sources (e.g., streetlights, light illuminated from other vehicles, moonlight, sunlight, etc.).

The light sensor 26 detects the illuminance outside the vehicle 10. The outside air temperature sensor 28 detects the temperature outside the vehicle 10.

The vehicle integrated control device 30 is a device that controls the entire vehicle. The vehicle integrated control device 30 is electrically connected to various control devices and various sensors. The controller 40 of the road surface drawing apparatus 32 acquires information from each device (the ESC device 20, the TRC device 22, the ABS device 24, the camera 25, the light sensor 26, and the outside air temperature sensor 28) via the vehicle integrated control device 30.

The controller 40 (the road surface drawing lamp control device 33) may set control information such as the lighting, extinguishing, brightness, position adjustment amount, and shape (image shape) on the road surface of the patterned light, and control the road surface drawing lamp 34 based on the control information.

The road surface drawing lamp 34 may be a lamp unit that irradiates and projects the patterned light onto the road surface. The road surface drawing lamp 34 may include a substrate, a light source, a heat sink, a shade (a light-shielding plate for generating the patterned light), a lens, and an actuator (a motor for changing the position of the patterned light).

FIG. 4 is a flowchart showing the processing performed by the controller 40 of the road surface drawing apparatus 32. In this processing, the controller 40 controls the execution and cancellation of a glare reduction control. When the glare reduction control is not performed or when the glare reduction control is cancelled (step S18 in FIG. 4), a normal control of the road surface drawing lamp 34 is performed. The normal control is the general control of the road surface drawing lamp 34. In the normal control, the controller 40 irradiates a predetermined patterned light (see FIG. 2) from the road surface drawing lamp 34 based on the turn signal Sts. At the time when the process in FIG. 4 is first performed or at the time before that, the normal control is set to be performed.

The processing shown in FIG. 4 is performed each time the vehicle 10 travels a fixed distance Dc. The fixed distance Dc is, for example, the range within which the headlights of the vehicle 10 can reach. The fixed distance Dc may be, for example, 40 m or thereabouts.

In step S10, the controller 40 checks whether the detection value of the outside air temperature sensor 28 is equal to or lower than a predetermined temperature Tth. Specifically, the controller 40 checks whether the outside temperature of the vehicle 10 is equal to or lower than a predetermined temperature Tth at which the road surface may freeze. The predetermined temperature Tth may be, for example, 3° C. or thereabouts. Step S10 is the determination of the first condition. In step S10, it is determined whether there is a possibility that water on the road surface freezes. If step S10 is No, the process proceeds to step S18.

In step S18, the controller 40 cancels the glare reduction control and performs the normal control of the road surface drawing lamp 34. When the glare reduction control is not being performed, the normal control of the road surface drawing lamp 34 is continued.

If step S10 is Yes, the process proceeds to step S12. In step S12, the controller 40 confirms whether the brightness of the light reflected toward the vehicle 10 from an area illuminated by a headlight of the vehicle 10 is equal to or lower than a predetermined brightness BRth. This is performed based on the image captured by the camera 25. Step S12 is the determination of the second condition.

The second condition is used to determine the nature of the road surface based on the brightness of the light reflected from the area illuminated by the headlight of vehicle 10 (referred to as the headlight illumination area) toward vehicle 10. Specifically, when the brightness of the reflected light in the headlight illumination area is high, the road surface can be determined to be a snow-covered road or similar surface where diffuse reflection is likely to occur (and specular reflection is unlikely to occur). On the other hand, when the brightness of the reflected light in the headlight illumination area is low, the road surface can be determined to be a mirror-smooth ice, etc. where diffuse reflection is unlikely to occur (and specular reflection is likely to occur).

If step S12 is No, the process proceeds to step S18. On the other hand, if step S12 is Yes, the process proceeds to step S14.

In step S14, the controller 40 checks whether at least one of the anti-lock brake control (ABS), the skid suppress control (ESC), and the traction control (TRC) has been activated during the most recent predetermined distance Dp traveled by the vehicle. The predetermined distance Dp may be, for example, three times the fixed distance Dc, which is the processing cycle in FIG. 4. In this case, the controller 40 checks whether the ABS, ESC, and TRC have been activated every time the vehicle travels the fixed distance Dc (every processing cycle in FIG. 4) and checks whether the ABS, ESC, and TRC have been activated during the most recent three processing cycles of FIG. 4. Additionally, the predetermined distance Dp may be, for example, 120 meters or thereabouts. Step S14 is the determination of the third condition. If the result of step S14 is No, the process proceeds to step S18.

If step S14 is Yes, the process proceeds to step S16. In step S16, the controller 40 performs a glare reduction control. In the glare reduction control, the irradiation of at least a part of the patterned light 50, 52 is stopped, the amount of light of at least a part of the patterned light 50, 52 is reduced, or the pattern of at least a part of the patterned light 50, 52 is changed.

According to the embodiment described above, a frozen road surface such as mirror-smooth ice, etc. where mirror reflection of the patterned light 50, 52 is likely to occur can be detected using the first condition (S10), the second condition (S12), and the third condition (S14). Then, when the frozen road surface such as mirror-smooth ice, etc. is detected, the glare reduction control that, for example, stops irradiation of at least a part of the patterned light 50, 52 is performed, so that the patterned light 50, 52 is prevented from being reflected by the frozen road surface and causing glare to people outside the vehicle.

In the embodiment described above, when the controller 40 performs the glare reduction control, if at least one of the first condition (S10), the second condition (S12), and the third condition (S14) is no longer satisfied, the glare reduction control is terminated (S18). That is, according to the above embodiment, it is possible to detect that the road surface around the vehicle 10 is not a frozen road surface prone to specular reflection of the patterned light 50, 52 by using the first condition (S10), the second condition (S12), and the third condition (S14). Then, when the glare reduction control is being performed, it is possible to terminate the glare reduction control and return the patterned light 50, 52 to its original form.

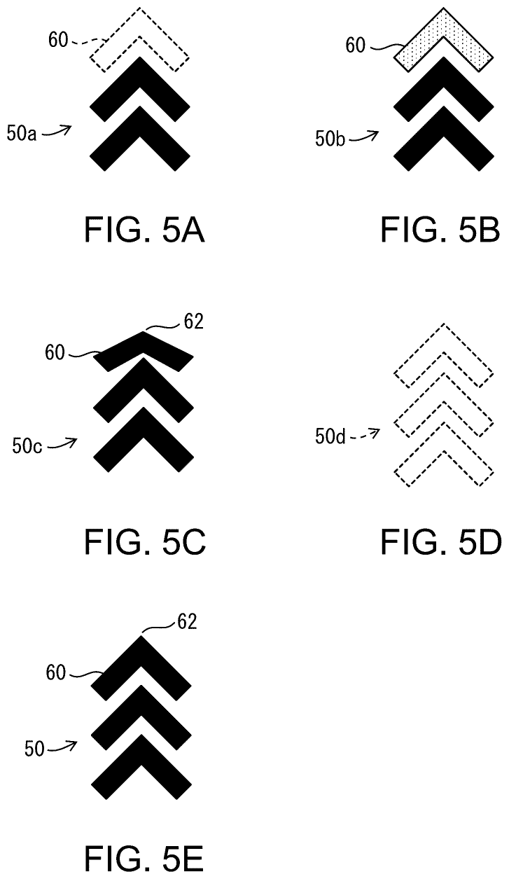

FIGS. 5A to 5E are examples of multiple types of the patterned light. FIGS. 5A to 5D show patterned lights 50a to 50d in the glare reduction control. FIG. 5E shows the patterned light 50 in the normal control. In the case of the normal control (when the glare reduction control is not performed), the patterned light 50 includes a distal pattern element 60 that is irradiated onto the road surface furthest from the vehicle 10.

The controller 40 may irradiate the pattern light 50a, which stops the irradiation of the distal pattern element 60 in the glare reduction control, onto the road surface as shown in FIG. 5A. This patterned light 50a is also shown at the bottom of FIG. 1. Compared to a part of the patterned light 50 irradiated onto the road surface relatively close to the vehicle 10, a part of the patterned light 50 (distal pattern element 60) irradiated onto the road surface relatively far from the vehicle 10 is reflected at a small angle with respect to the road surface and travels forward (see the upper part of FIG. 1), so the reflected light is easily irradiated onto the face of the person 100 outside the vehicle. In glare reduction control, by stopping irradiation of the distal pattern element 60 of the patterned light 50, it is possible to suppress the reflected light from being irradiated onto the face of the person 100, as shown in the lower part of FIG. 1. In glare reduction control, the controller 40 may irradiate a patterned light, which is patterned light in which the distal pattern element 60 and light element (middle pattern element) adjacent to the distal pattern element 60 are stopped, onto the road surface.

In addition, as shown in FIG. 5B, the controller 40 may irradiate the patterned light 50b, which has a reduced amount of light of the distal pattern element 60 compared to the normal control, onto the road surface in glare reduction control. According to this configuration, since the amount of light of the distal pattern element 60 is reduced, the amount of reflected light that may be irradiated onto a person's face can be reduced. In the glare reduction control, the controller 40 may reduce the amount of light of the distal pattern element 60 and light element (middle light) adjacent to the distal pattern element 60, or may reduce the total amount of light of the patterned light.

In addition, as shown in FIG. 5C, the controller 40, in the glare reduction control, may irradiate the patterned light 50c, which has a modified shape of the distal pattern element 60 of the patterned light 50c such that a tip 62 of the distal pattern element 60 of the patterned light 50c on the road surface is closer to the vehicle 10 than in the normal control. With this configuration, the tip 62 of the distal pattern element 60 of the patterned light 50c on the road surface becomes closer to the vehicle 10, i.e., the patterned light 50c is no longer irradiated onto the road surface relatively far from the vehicle 10, thereby suppressing the irradiation of reflected light onto a person's face. In the glare reduction control, the controller 40 may change the pattern of the light element (middle light) adjacent to the distal pattern element 60 in addition to the distal pattern element 60, or may change the overall pattern of the patterned light.

In addition, as shown in FIG. 5D, the controller 40 may stop irradiating the entire patterned light in the glare reduction control.

The road surface drawing lamp 34 may be configured to irradiate and project the patterned light onto the road surface to enable people outside the vehicle to recognize the approach of vehicle 10 at an early stage. The road surface drawing lamp 34 may be provided only at the front of the vehicle 10. Additionally, the road surface drawing lamp 34 may be provided not only at the front and rear of the vehicle 10 but also at the sides of the vehicle 10. The glare reduction control may be applied to at least one of the road surface drawing lamp 34 at the front, rear, and sides of the vehicle 10.

According to the embodiment described above, it is possible to detect a frozen road surface 110 where mirror reflection of the patterned light 50, 52 is likely to occur using control devices and sensors generally provided in vehicle 10. Therefore, it is possible to suppress cost increases due to the installation of new sensors, etc.

In the embodiment described above, the controller 40 performed the glare reduction control in accordance with the fulfillment of multiple conditions. However, the controller 40 may check whether the anti-lock brake control (ABS) was activated during the most recent predetermined distance Dp of vehicle travel each time the vehicle travels a fixed distance Dc, and perform the glare reduction control if it was activated, and perform the normal control if it was not activated. In addition to this ABS condition, the controller 40 may perform the glare reduction control when at least one of the first condition (S10) and the second condition (S12) is satisfied, and perform the normal control when neither condition is satisfied.

In addition, the controller 40 may confirm whether the skid suppress control (ESC) has been activated during the most recent predetermined distance Dp of vehicle travel each time the vehicle travels a fixed distance Dc, and if it has been activated, perform the glare reduction control, and if it has not been activated, perform the normal control. In addition to the condition of the ESC, the controller 40 may perform the glare reduction control when at least one of the first condition (S10) and the second condition (S12) is satisfied, and perform the normal control when neither of the first condition and the second condition is satisfied.

In addition, the controller 40 may confirm whether the traction control (TRC) has been activated during the most recent predetermined distance Dp of vehicle travel each time the vehicle travels a fixed distance Dc, and may perform the glare reduction control if the traction control has been activated, and may perform the normal control if the traction control has not been activated. In addition, the controller 40 may perform the glare reduction control when at least one of the first condition (S10) and the second condition (S12) is satisfied in addition to the TRC condition, and perform the normal control when neither of the first condition and the second condition is satisfied.

In addition, the controller 40 may check whether the first condition (S10) and the second condition (S12) are satisfied each time the vehicle travels a fixed distance Dc, and perform the glare reduction control when both the first condition (S10) and the second condition (S12) are satisfied, and perform the normal control when they are not satisfied.

1. A road surface drawing apparatus for a vehicle, comprising:
a road surface drawing lamp that irradiates a patterned light toward a road surface; and
a controller that controls the road surface drawing lamp,
wherein
the controller determines a plurality of conditions including a first condition, a second condition, and a third condition each time the vehicle travels a fixed distance,
the first condition is that an outside temperature of the vehicle is equal to or lower than a predetermined temperature at which the road surface may freeze,
the second condition is that a brightness of light reflected toward the vehicle from an area illuminated by a headlight of the vehicle is equal to or lower than a predetermined brightness,
the third condition is that at least one of an anti-lock brake control, which suppresses wheels of the vehicle from locking, a skid suppress control, which suppresses the vehicle from skidding, and a traction control, which suppresses wheels of the vehicle from spinning, has been activated during the most recent predetermined distance traveled by the vehicle, and
the controller performs a glare reduction control that stops irradiation of at least a part of the patterned light, reduces the amount of light of at least a part of the patterned light, or changes a pattern of at least a part of the patterned light when the plurality of conditions is satisfied.

2. The road surface drawing apparatus for vehicle according to claim 1, wherein
the controller determines the plurality of conditions each time the vehicle travels the fixed distance during which the glare reduction control is performed, and terminates the glare reduction control when at least one of the first condition, the second condition, and the third condition is no longer satisfied.

3. The road surface drawing apparatus for vehicle according to claim 1, wherein
the patterned light includes a distal pattern element that is irradiated onto the road surface furthest from the vehicle when the glare reduction control is not performed, and
the controller stops irradiation of at least the distal pattern element of the patterned light in the glare reduction control.

4. The road surface drawing apparatus for vehicle according to claim 2, wherein
the patterned light includes a distal pattern element that is irradiated onto the road surface furthest from the vehicle when the glare reduction control is not performed, and
the controller stops irradiation of at least the distal pattern element of the patterned light in the glare reduction control.

5. The road surface drawing apparatus for vehicle according to claim 1, wherein
the patterned light includes a distal pattern element that is irradiated onto the road surface furthest from the vehicle, and
the controller reduces the amount of light of at least the distal pattern element of the patterned light in the glare reduction control compared to when the glare reduction control is not performed.

6. The road surface drawing apparatus for vehicle according to claim 2, wherein
the patterned light includes a distal pattern element that is irradiated onto the road surface furthest from the vehicle, and
the controller reduces the amount of light of at least the distal pattern element of the patterned light in the glare reduction control compared to when the glare reduction control is not performed.

7. The road surface drawing apparatus for vehicle according to claim 1, wherein
the patterned light includes a distal pattern element that is irradiated onto the road surface furthest from the vehicle, and
the controller, in the glare reduction control, changes a shape of the distal pattern element of the patterned light such that a tip of the distal pattern element of the patterned light on the road surface is closer to the vehicle than when the glare reduction control is not performed.

8. The road surface drawing apparatus for vehicle according to claim 2, wherein
the patterned light includes a distal pattern element that is irradiated onto the road surface furthest from the vehicle, and
the controller, in the glare reduction control, changes a shape of the distal pattern element of the patterned light such that a tip of the distal pattern element of the patterned light on the road surface is closer to the vehicle than when the glare reduction control is not performed.
